(19) United States
(12) Patent Application Publication
(10) Pub. No.: US 2015/0022671 A1
(43) Pub. Date: Jan. 22, 2015

(54) Electronic Device, Control Method of Electronic Device and Recording Medium Storing Control Program of Electronic Device

(71) Applicants: Kabushiki Kaisha Toshiba, Tokyo (JP); Toshiba Lifestyle Products & Services Corporation, Tokyo (JP)

(72) Inventor: Katsuya Ohno, Tokyo (JP)

(21) Appl. No.: 14/318,360

(22) Filed: Jun. 27, 2014

(30) Foreign Application Priority Data
Jul. 17, 2013 (JP) 2013-148822

(51) Int. Cl. H04N 21/442; H04N 17/00; H04N 17/04

(52) U.S. Cl. CPC H04N 21/44231; H04N 17/04; H04N 17/004
USPC 348/189

(57) ABSTRACT

An electronic device to which a plurality of expansion units for function expansion are connectable, includes an image processing portion configured to receive an image signal from the expansion unit, apply predetermined processing to the image signal and output the resulting image signal to a displaying portion; and a controller configured to output a failure diagnosis result of the expansion unit as a result of executing a failure detection program stored in the expansion unit for the expansion unit or a failure detection program acquired from outside for the expansion unit.

### CROSS REFERENCE TO RELATED APPLICATIONS

This application is based upon and claims the benefit of priority from the prior Japanese Patent Application No. 2013-148822, filed on Jul. 17, 2013; the entire contents of which are incorporated herein by reference.

### FIELD

Embodiments described herein relate generally to an electronic device, a control method of the electronic device and a recording medium storing a control program of the electronic device.

### BACKGROUND

As an electronic device that displays an image such as a television, an electronic device is studied in which the functions of the electronic device are enhanced by connection to an expansion unit. There is a possibility that expansion units of various functions are connected to the electronic device. Therefore, in a case where a certain expansion unit breaks down and becomes impossible to be used according to the user's intention, it may become difficult to specify the broken expansion unit.

Moreover, since there can be many kinds of expansion units that can be connected to the electronic device, it is actually difficult to store the failure detection program of each expansion unit in the electronic device.

### BRIEF DESCRIPTION OF THE DRAWINGS

FIG. 1 is a schematic diagram illustrating a configuration of an electronic device 1 according to an embodiment of the present invention and expansion units 21, 22 and 23 connected to the electronic device 1;

FIG. 2 is a diagram illustrating the electronic device 1 together with a server 31 and a user support center 32 which are connected to the electronic device 1 through a network;

FIG. 3 is a flowchart to describe a control method of the electronic device 1;

FIG. 4 illustrates an example of screen display showing the connection state of expansion units; and

FIG. 5 illustrates an example of screen display showing a failure diagnosis result of expansion units.

### DETAILED DESCRIPTION

According to an embodiment, there is provided an electronic device to which a plurality of expansion units for function expansion are connectable, where the electronic device includes an image processing portion configured to receive an image signal from the expansion unit, apply predetermined processing to the image signal and output the resulting image signal to a displaying portion, and a controller configured to output a failure diagnosis result of the expansion unit as a result of executing a failure detection program stored in the expansion unit for the expansion unit or a failure detection program acquired from the outside for the expansion unit.

Embodiments will now be explained with reference to the accompanying drawings.

(Electronic Device)

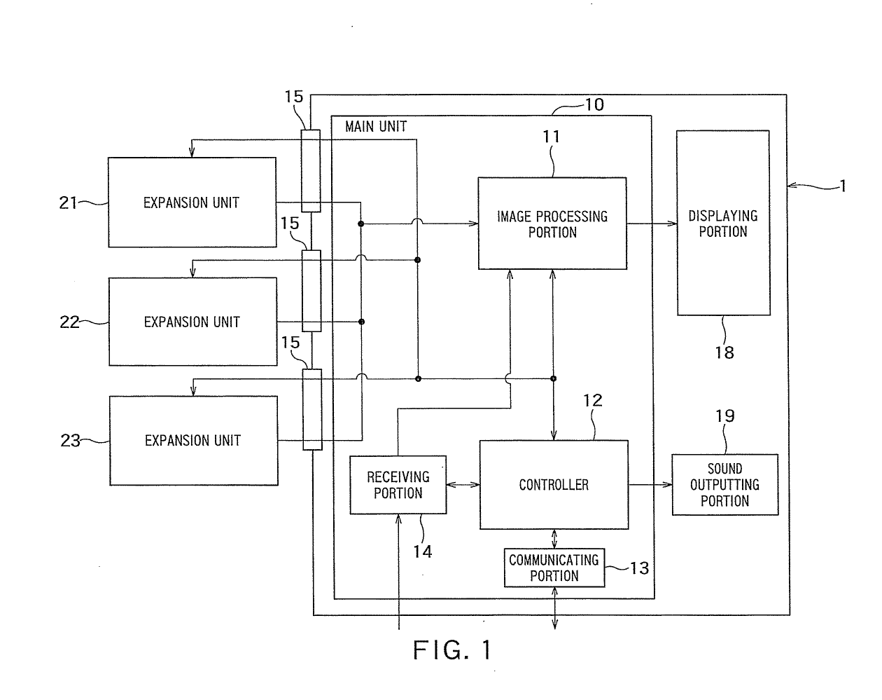

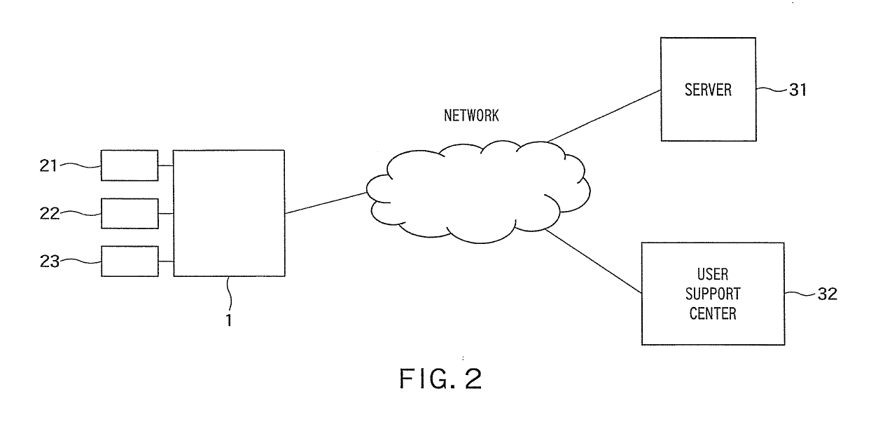

The electronic device 1 according to an embodiment of the present invention is described with reference to FIG. 1 and FIG. 2. FIG. 1 illustrates a schematic configuration of the electronic device 1 and the three expansion units 21, 22 and 23 connected to the electronic device 1. FIG. 2 illustrates the electronic device 1 together with the server 31 and the user support center 32 which are connected to the electronic device 1 through a network.

The electronic device 1 is an electronic device to which a plurality of expansion units for function expansion can be connected, and denotes an image display apparatus such as a television. Here, the electronic device 1 is not limited to the television and may be a tablet terminal, a smart phone or a personal computer, and so on.

In the example illustrated in FIG. 1, the three expansion units 21, 22 and 23 are connected to the electronic device 1. The expansion units 21, 22 and 23 are not limited to be connected to the electronic device 1 by wired connection as illustrated in FIG. 1, and may be connected to the electronic device 1 by wireless connection.

Moreover, as illustrated in FIG. 2, the electronic device 1 may be connected to the external server 31 and the external user support center 32 via a network such that communication is possible. In this case, the server 31 stores the failure detection program of each of the expansion units 21, 22 and 23. Preferably, the server 31 stores the failure detection programs of the latest version.

The expansion units 21, 22 and 23 are units to expand the functions of the electronic device 1 (or the main unit 10). For example, the expansion units 21, 22, and 23 denote a tuner, an image playback device such as a BD (Blu-ray Disc) player, a hard disk drive (HDD) for recording or a high image quality unit that improves the image quality of an input image (for example, converts it into a 4K image) and outputs the result.

The above-mentioned expansion units 21, 22 and 23 are formed so as to be detachable to a connecting portion 15 of the electronic device 1. For example, the expansion units 21, 22 and 23 are card types and may be attached to the connecting portion 15 of a card slot shape. Alternatively, the expansion units 21, 22 and 23 may include a terminal cable attached to the connecting portion 15, and may be connected to the electronic device 1 through the terminal cable.

Here, although the expansion units are connected to all of three connecting portions 15 of the electronic device 1 in FIG. 1, it is not essential that the expansion units are connected to all of the connecting portions 15. An expansion unit that provides a desired function only has to be connected to the electronic device 1, and the connecting portion 15 to which an expansion unit is not connected may be present.

Moreover, an expansion unit may be connected to the electronic device 1 according to the specification of the destination of a product.

Moreover, the expansion units 21, 22 and 23 may include a storage portion (not illustrated) that stores a failure detection program to detect their own failures, and a processing portion (not illustrated) such as a microprocessor that executes the failure detection program.

Next, the structure of the electronic device 1 is described in detail. As illustrated in FIG. 1, the electronic device 1 includes the main unit 10 on which a communication function with the expansion units 21, 22 and 23, an image processing function, and so on are mounted, the connecting portion 15 for connection to the expansion units 21, 22 and 23, a displaying portion 18 that displays an image processed by the main unit 10 (or an image processing portion 11), and a sound output portion (speaker) 19 that outputs sound based on a sound signal output from the main unit 10.

The connecting portion 15 is, for example, a USB port, a HDMI terminal, a card slot, and so on. In FIG. 1, although the electronic device 1 has the three connecting portions 15, the number of the connecting portions 15 is not limited to this and an arbitrary number is possible.

The displaying portion 18 is a graphic display device such as a liquid crystal panel, a plasma panel or an organic EL panel.

The sound outputting portion 19 is connected to a controller 12 and outputs sound associated with images displayed on the displaying portion 18. Moreover, the sound outputting portion 19 may output a failure diagnosis result of an expansion unit by sound.

Next, the structure of the main unit 10 is described. The main unit 10 has the image processing portion 11, the controller 12, a communicating portion 13 and a receiving portion 14.

The image processing portion 11 receives an image signal from the expansion units 21, 22, and 23 or the receiving portion 14, applies predetermined processing to the image signal and outputs the resulting image signal to the displaying portion 18. Here, the predetermined processing is, for example, necessary processing to display an image based on the image signal received by the image processing portion 11 on the displaying portion 18.

The controller 12 also has a function of controlling the expansion units 21, 22 and 23 connected to the electronic device 1 in addition to a function of controlling the entire of the electronic device 1. For example, the controller 12 is formed with a microprocessor.

Moreover, the controller 12 may have a memory to store a failure detection program acquired from the expansion units 21, 22 and 23, the server 31, or the like.

The controller 12 outputs the failure diagnosis results of the expansion units 21, 22 and 23 connected to the electronic device 1, to the displaying portion 18 through the image processing portion 11. Here, the failure diagnosis results are results of executing the failure detection programs stored in the expansion units 21, 22 and 23 for the expansion units or the failure detection programs acquired from the outside for the expansion units 21, 22 and 23.

As described later in detail, the failure detection programs may be executed by the controller 12 or may be executed by the expansion units 21, 22 and 23.

Also, the controller 12 may output the failure diagnosis results of the expansion units 21, 22 and 23 to the sound outputting portion 19 instead of or together with the displaying portion 18. By this means, even in a case where an expansion unit such as a high image quality unit breaks down and an image cannot be displayed at all, it is possible to notify the user of the failure diagnosis results.

Moreover, the controller 12 may notify the user support center 32 of the failure diagnosis results by way of a network. By this means, it is possible to notify the user support center of the failure diagnosis results without notification from the user to the user support center.

The communicating portion 13 is connected to the network by wired connection or wireless connection, and performs communication with the server 31 and the user support center 32 through the network.

The receiving portion 14 is connected to an antenna or the like and receives a broadcast wave. The receiving portion 14 transmits an image signal included in the received broadcast wave to the image processing portion 11 and transmits various kinds of data (such as a failure detection program) included in the broadcast wave to the controller 12.

In the present embodiment, the failure detection programs for the expansion units 21, 22 and 23 are stored in the expansion units 21, 22 and 23, respectively, or acquired from the outside (the server 31 or the broadcast wave). Therefore, the electronic device 1 does not have to store the failure detection program of each of the expansion units 21, 22 and 23.

Therefore, according to the electronic device 1, it is not necessary to install a memory to store the failure detection program for each of the expansion units 21, 22 and 23 in the electronic device 1. Moreover, it is also possible to perform failure diagnosis with respect to an expansion unit that is developed and sold after the electronic device 1 was sold.

In addition, according to the electronic device 1, since the result of executing the failure detection program for each of the expansion units 21, 22 and 23 is output as a failure diagnosis result, the user or the user support center can easily specify a broken expansion unit. By this means, for example, the user can notify the user support center of the specified malfunction part or replace only the expansion unit subjected to failure diagnosis. As a result, it is possible to enhance the user's convenience.

The expansion unit failure detection program may be executed by the electronic device 1 (or the controller 12) or may be executed by each of the expansion units 21, 22 and 23. Moreover, as described above, the failure detection program may be stored in the expansion units 21, 22 and 23 or may be acquired from the outside (the server 31 and the broadcast wave). Therefore, following six embodiments are thought of from combinations of the execution subjects of the failure detection program (two kinds) and the storage places of the failure detection program (three kinds).

Embodiments 1 to 3 are embodiments in a case where the expansion units 21, 22 and 23 execute the failure detection program, and Embodiments 4 to 6 are embodiments in a case where the electronic device 1 (or the controller 12) executes the failure detection program.

### Embodiment 1

In this embodiment, the execution subject of the failure detection program is each of the expansion units 21, 22 and 23, and the failure detection program is stored in each of the expansion units 21, 22 and 23.

In this case, the controller 12 instructs the expansion unit 21, which is a diagnosis target, to execute the failure detection program stored in the expansion unit 21. After that, the controller 12 receives the failure diagnosis result from the expansion unit 21 and outputs it to the displaying portion 18 or the like as described above.

According to Embodiment 1, since the failure detection program is stored in an expansion unit and executed by the expansion unit, it is possible to promptly start execution of the failure detection program.

Moreover, according to Embodiment 1, since the failure detection program is stored in the expansion unit, even in a case where the electronic device 1 cannot receive a broadcast wave or a case where the electronic device 1 is not network-connected, it is possible to perform failure diagnosis.

### Embodiment 2

In this embodiment, the execution subject of the failure detection program is each of the expansion units 21, 22 and 23, and the failure detection program is stored in the server 31.

In this case, the controller 12 downloads the failure detection program for the expansion unit 21, which is a diagnosis target, from the server 31 into the expansion unit 21 through the communicating portion 13.

Here, the failure detection program for the expansion unit 21, which is a diagnosis target, may be acquired using an identifier (ID) of the expansion unit 21. To be more specific, the controller 12 may acquire the identifier unique to the expansion unit by accessing the expansion unit which is a diagnosis target and download the failure detection program for the expansion unit from the server 31 by the use of the identifier.

After downloading the failure detection program from the server 31, the controller 12 instructs the expansion unit 21 to execute the failure detection program. After that, the controller 12 receives the failure diagnosis result from the expansion unit 21 and outputs it to the displaying portion 18 or the like as described above.

According to Embodiment 2, it is not necessary to store the failure detection program in advance in the expansion unit. Moreover, since it becomes possible to use the latest failure detection program, it is possible to implement more accurate failure diagnosis.

### Embodiment 3

In this embodiment, the execution subject of the failure detection program is each of the expansion units 21, 22 and 23, and the failure detection program is included in a broadcast wave.

In this case, the controller 12 stores in the expansion unit 21 the failure detection program of the expansion unit 21, which is a diagnosis target, included in the broadcast wave.

Here, the failure detection program for the expansion unit, which is a diagnosis target, may be acquired using an identifier (ID) of the expansion unit. To be more specific, the controller 12 may acquire the identifier unique to the expansion unit by accessing the expansion unit which is a diagnosis target and extract the failure detection program for the expansion unit from the broadcast wave by the use of the identifier.

After storing the failure detection program in the expansion unit which is a diagnosis target, the controller 12 instructs the expansion unit 21 to execute the failure detection program. After that, the controller 12 receives the failure diagnosis result from the expansion unit 21.

According to Embodiment 3, it is not necessary to store the failure detection program in advance in the expansion unit. Moreover, even in a case where the electronic device 1 is not network-connected, it is possible to perform failure diagnosis. In addition, since it becomes possible to use the latest failure detection program, it is possible to implement more accurate failure diagnosis.

### Embodiment 4

In this embodiment, the execution subject of the failure detection program is the electronic device 1 and the failure detection program is stored in each of the expansion units 21, 22 and 23.

In this case, the controller 12 acquires the failure detection program stored in the expansion unit 21 which is a diagnosis target and executes it.

According to Embodiment 4, since the failure detection program is stored in the expansion units, even in a case where the electronic device 1 cannot receive a broadcast wave or a case where the electronic device 1 is not network-connected, it is possible to perform failure diagnosis.

### Embodiment 5

In this embodiment, the execution subject of the failure detection program is the electronic device 1 and the failure detection program is stored in the server 31.

In this case, the controller 12 acquires the failure detection program for the expansion unit 21, which is a diagnosis target, from the server 31 through the communicating portion 13 and executes it.

According to Embodiment 5, it is not necessary to store the failure detection program in advance in the expansion unit. Moreover, since it becomes possible to use the latest failure detection program, it is possible to implement more accurate failure diagnosis.

### Embodiment 6

In this embodiment, the execution subject of the failure detection program is the electronic device 1 and the failure detection program is included in a broadcast wave.

In this case, the controller 12 acquires the failure detection program of the expansion unit 21, which is a diagnosis target, included in the broadcast wave received by the receiving portion 14, and executes it.

According to Embodiment 6, it is not necessary to store the failure detection program in advance in the expansion unit. Moreover, since it becomes possible to use the latest failure detection program, it is possible to implement more accurate failure diagnosis.

Also, in Embodiments 4 to 6, the failure detection program may be stored in the memory in the controller 12 or may be stored in a memory (not illustrated) installed outside the controller 12.

(Control Method of Electronic Device)

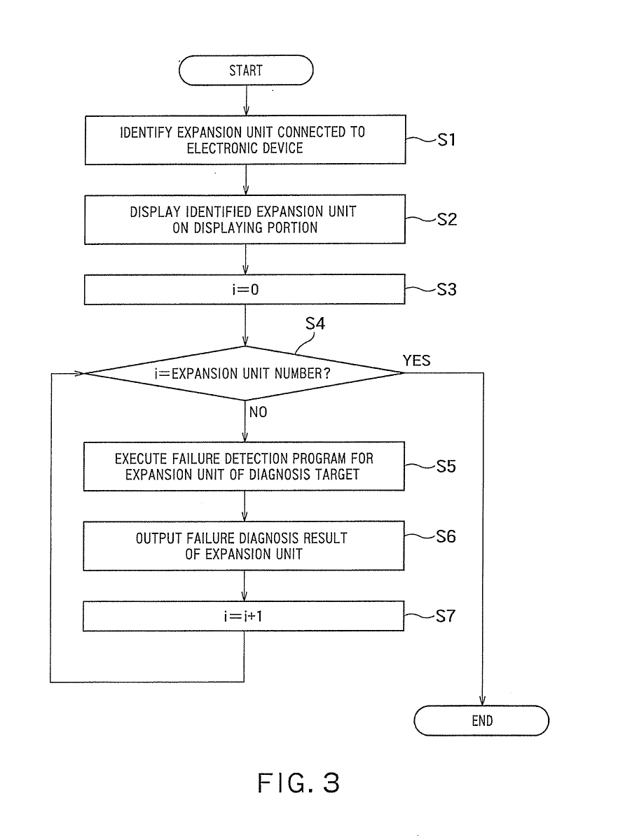

Next, as a control method of the electronic device 1, a failure detection method of the expansion units 21, 22 and 23 is described along the flowchart in FIG. 3. Also, this failure detection method is implemented when an instruction from the user is received, when the electronic device 1 is activated, or when it is predetermined time.

First, the expansion units 21, 22 and 23 connected to the electronic device 1 are identified (step S1). To be more specific, the controller 12 accesses the expansion units 21, 22 and 23, and acquires information such as the identifiers of the expansion units 21, 22 and 23. Subsequently, the controller 12 records the identification result in a predetermined memory (such as the memory in the controller 12).

Also, in a case where the identification processing of the expansion units is performed at the timing when the expansion units are connected to the electronic device 1 and where the identification result is recorded in the main unit 10, only communication confirmation to the expansion units may be performed.

Moreover, in the case of a mode in which the electronic device 1 executes the failure detection program stored in the expansion units, in this step, the failure detection program stored in the identified expansion units may be stored in the electronic device 1.

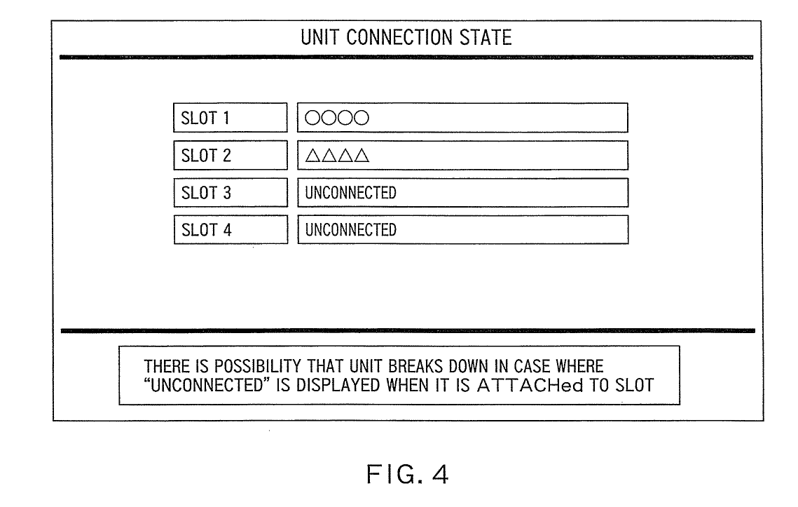

Next, the identified expansion units are displayed on the displaying portion 18 (step S2). FIG. 4 illustrates an example of screen display showing the connection states of the expansion units. The display example in FIG. 4 shows that expansion units are connected to slots 1 and 2.

Also, in a case where an expansion unit is not identified while being connected to the electronic device 1, at the timing of this step, it is understood that there is a possibility of poor connection in the connecting portion 15 or there is a possibility that the expansion unit breaks down.

Next, a unit number parameter (i) is reset (step S3). That is, the unit number parameter (i) is adjusted to 0.

Next, it is determined whether the unit number parameter (i) equals to the number of expansion units identified in step S1 (step S4). In a case where the unit number parameter (i) equals to the number of expansion units, the failure diagnosis is implemented for all of the identified expansion units and therefore the failure diagnosis flow is terminated. On the other hand, in a case where the unit number parameter (i) does not equal to the number of expansion units, it proceeds to step S5 to implement the failure diagnosis with respect to the next expansion unit.

In step S5, a failure detection program for an expansion unit, which is a diagnosis target, is executed. The failure detection program is a failure detection program stored in the expansion unit for the expansion unit or a failure detection program acquired from the outside (the server 31 or a broadcast wave).

Also, as described above, the failure detection program may be executed by the electronic device 1 (or the controller 12) or may be executed by the expansion unit which is a diagnosis target. In a case where the electronic device 1 executes the failure detection program, the failure detection program for the expansion unit, which is a diagnosis target, is stored in the memory in the electronic device 1 (such as the memory in the controller 12) and then the failure detection program is executed.

After the failure detection program is executed, the failure diagnosis result of the expansion unit is output (step S6). The controller 12 outputs the failure diagnosis result to at least one of the displaying portion 18, the sound outputting portion 19 and the user support center 32. For example, by outputting the diagnosis result to the user support center 32, it is possible to inform the user of a specific countermeasure with respect to the failure without the user's inquiry to the user support center 32.

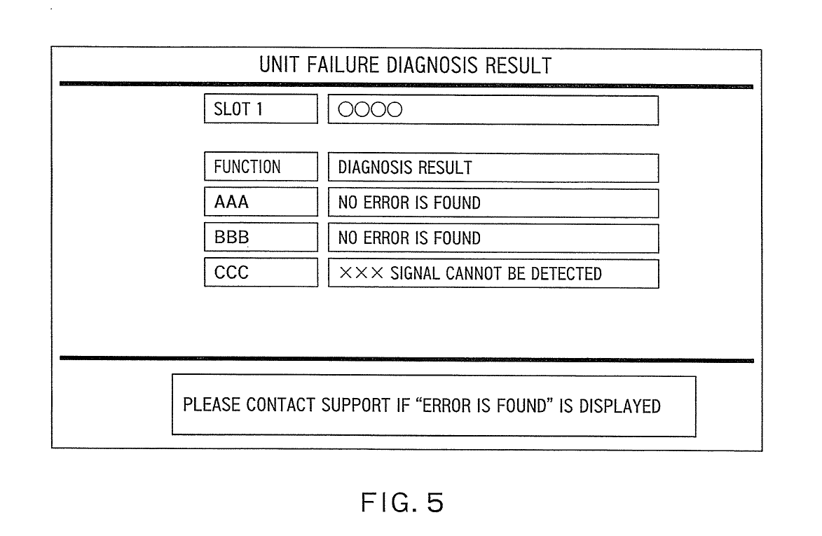

FIG. 5 illustrates an example of screen display showing a failure diagnosis result. In this display example, the diagnosis result of the expansion unit connected to the slot 1 is displayed. Also, as illustrated in FIG. 5, in a case where the expansion unit has a plurality of functions, the diagnosis result may be displayed for each of the functions (AAA, BBB and CCC) of the expansion unit. By executing the failure detection program unique to the expansion unit which is a diagnosis target, it is possible to diagnose even the detailed functions of the expansion unit in this way.

Also, in a case where detected malfunction is based on software of the expansion unit, the electronic device 1 may acquire update software to overcome the malfunction from the server 31 or a broadcast wave, and store it in the expansion unit.

After the diagnosis result is output, the unit number parameter (i) is increased by one and it returns to step S4 (step S7). Thus, the failure diagnosis is sequentially performed on the expansion unit identified in step S1 and the result is output to the displaying portion 18 or the like.

At least part (such as the controller 12) of the electronic device 1 described in the above-mentioned embodiment may be formed by hardware or software. In the case of forming it by software, a program to realize at least part of the functions of the electronic device 1 may be stored in a recording medium such as a flexible disk and a CD-ROM, read out and executed by the computer. The recording medium is not limited to be detachable such as a magnetic disk and an optical disc, and may be a fixed recording media such as a hard disk drive and a memory.

Moreover, the program to realize at least part of the functions of the electronic device 1 may be distributed through a communication line (including wireless communication) such as the Internet. In addition, while this program is encrypted, modulated or compressed, it may be distributed through a wired line or wireless line such as the Internet or may be stored in a recording medium and distributed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the following embodiments can be assumed.

(Appendix 1)

An electronic device (1) to which a plurality of expansion units (21, 22, 23) for function expansion are connectable, comprising:

an image processing portion (11) configured to receive an image signal from the expansion unit (21, 22, 23), apply predetermined processing to the image signal and output the resulting image signal to a displaying portion (18); and

a controller (12) configured to output a failure diagnosis result of the expansion unit (21, 22, 23) as a result of executing a failure detection program stored in the expansion unit (21, 22, 23) for the expansion unit (21, 22, 23) or a failure detection program acquired from outside for the expansion unit (21, 22, 23).

(Appendix 2)

The electronic device (1) of Appendix 1, wherein the controller (12) instructs the expansion unit (21), which is a diagnosis target, to execute the failure detection program stored in the expansion unit (21), and receives the failure diagnosis result from the expansion unit(21).

(Appendix 3)

The electronic device (1) of Appendix 1, further comprising a communicating portion (13) configured to be able to communicate with a server (31) storing the failure detection program through a network,

wherein the controller (12) downloads the failure detection program for the expansion unit (21), which is a diagnosis target, from the server (31) to the expansion unit (21) through the communicating portion (13), instructs the expansion unit (21) to execute the failure detection program and receives the failure diagnosis result from the expansion unit (21).

(Appendix 4)

The electronic device (1) of Appendix 1, further comprising a receiving portion (14) configured to receive a broadcast wave,

wherein the controller (12) stores in the expansion unit (21) the failure detection program of the expansion unit (21), which is a diagnosis target, included in the broadcast wave received by the receiving portion (14), instructs the expansion unit (21) to execute the failure detection program and receives the failure diagnosis result from the expansion unit (21).

(Appendix 5)

The electronic device (1) of Appendix 1, wherein the controller (12) acquires and executes the failure detection program stored in the expansion unit (21) which is a diagnosis target.

(Appendix 6)

The electronic device (1) of Appendix 1, further comprising a communicating portion (13) configured to be able to communicate with a server (31) storing the failure detection program through a network,

wherein the controller (12) acquires the failure detection program for the expansion unit (21), which is a diagnosis target, from the server (31) through the communicating portion (13) and executes the failure detection program.

(Appendix 7)

The electronic device (1) of Appendix 1, further comprising a receiving portion (14) configured to receive a broadcast wave,

wherein the controller (12) acquires and executes the failure detection program of the expansion unit (21), which is a diagnosis target, included in the broadcast wave received by the receiving portion (14).

(Appendix 8)

The electronic device (1) of Appendix 1, wherein the controller (12) outputs the failure diagnosis result to the displaying portion (18) through the image processing portion (11).

(Appendix 9)

The electronic device (1) of Appendix 1, wherein the controller (12) outputs the failure diagnosis result to a sound outputting portion (19).

(Appendix 10)

The electronic device (1) of Appendix 1, wherein the controller (12) notifies a user support center (32) of the failure diagnosis result by way of a network.

(Appendix 11)

The electronic device (1) of Appendix 1, wherein the expansion unit (21) is a tuner, an image playback device, a hard disk drive for recording or a high image quality unit.

(Appendix 12)

A control method of an electronic device (1), comprising:

identifying an expansion unit (21, 22, 23) connected to the electronic device;

executing a failure detection program stored in the expansion unit (21, 22, 23) for the expansion unit (21, 22, 23) or a failure detection program acquired from outside for the expansion unit (21, 22, 23); and

outputting a failure diagnosis result of the expansion unit (21, 22, 23) as a result of executing the failure detection program.

(Appendix 13)

The control method of the electronic device (1) of Appendix 12, wherein the failure detection program is acquired from a server (31) connected to the electronic device (1) via a network.

(Appendix 14)

The control method of the electronic device (1) of Appendix 12, wherein the failure detection program is acquired from a broadcast wave received by the electronic device (1).

(Appendix 15)

The control method of the electronic device (1) of Appendix 12, wherein the failure diagnosis result is output to at least one of a displaying portion (18) of the electronic device (1), a sound outputting portion (19) of the electronic device and a user support center (32) connected to the electronic device via a network.

(Appendix 16)

The control method of the electronic device (1) of Appendix 12, wherein the expansion unit (21) is a tuner, an image playback device, a hard disk drive for recording or a high image quality unit.

(Appendix 17)

A control program of an electronic device (1) to cause a computer to:

identify an expansion unit (21) connected to the electronic device;

execute a failure detection program stored in the expansion unit (21) for the expansion unit (21) or a failure detection program acquired from outside for the expansion unit (21); and

output a failure diagnosis result of the expansion unit (21) as a result of executing the failure detection program.

(Appendix 18)

The control program of Appendix 17, wherein the control program is configured to cause the computer further to acquire the failure detection program from a server (31) connected to the electronic device (1) via a network.

(Appendix 19)

The control program of Appendix 17, wherein the control program is configured to cause the computer further to acquire the failure detection program from a broadcast wave received by the electronic device (1).

(Appendix 20)

The control program of Appendix 17, wherein the control program is configured to cause the computer further to output the failure diagnosis result to at least one of a displaying portion (18) of the electronic device, a sound outputting portion (19) of the electronic device and a user support center (32) connected to the electronic device (1) via a network.

1. An electronic device to which a plurality of expansion units for function expansion are connectable, comprising:
an image processing portion configured to receive an image signal from the expansion unit, apply predetermined processing to the image signal and output the resulting image signal to a displaying portion; and
a controller configured to output a failure diagnosis result of the expansion unit as a result of executing a failure detection program stored in the expansion unit for the expansion unit or a failure detection program acquired from outside for the expansion unit.

2. The electronic device of claim 1, wherein the controller instructs the expansion unit, which is a diagnosis target, to execute the failure detection program stored in the expansion unit, and receives the failure diagnosis result from the expansion unit.

3. The electronic device of claim 1, further comprising a communicating portion configured to be able to communicate with a server storing the failure detection program through a network,
wherein the controller downloads the failure detection program for the expansion unit, which is a diagnosis target, from the server to the expansion unit through the communicating portion, instructs the expansion unit to execute the failure detection program and receives the failure diagnosis result from the expansion unit.

4. The electronic device of claim 1, further comprising a receiving portion configured to receive a broadcast wave,
wherein the controller stores in the expansion unit the failure detection program of the expansion unit, which is a diagnosis target, included in the broadcast wave received by the receiving portion, instructs the expansion unit to execute the failure detection program and receives the failure diagnosis result from the expansion unit.

5. The electronic device of claim 1, wherein the controller acquires and executes the failure detection program stored in the expansion unit which is a diagnosis target.

6. The electronic device of claim 1, further comprising a communicating portion configured to be able to communicate with a server storing the failure detection program through a network,
wherein the controller acquires the failure detection program for the expansion unit, which is a diagnosis target, from the server through the communicating portion and executes the failure detection program.

7. The electronic device of claim 1, further comprising a receiving portion configured to receive a broadcast wave,
wherein the controller acquires and executes the failure detection program of the expansion unit, which is a diagnosis target, included in the broadcast wave received by the receiving portion.

8. The electronic device of claim 1, wherein the controller outputs the failure diagnosis result to the displaying portion through the image processing portion.

9. The electronic device of claim 1, wherein the controller outputs the failure diagnosis result to a sound outputting portion.

10. The electronic device of claim 1, wherein the controller notifies a user support center of the failure diagnosis result by way of a network.

11. The electronic device of claim 1, wherein the expansion unit is a tuner, an image playback device, a hard disk drive for recording or a high image quality unit.

12. A control method of an electronic device, comprising:
identifying an expansion unit connected to the electronic device;
executing a failure detection program stored in the expansion unit for the expansion unit or a failure detection program acquired from outside for the expansion unit; and
outputting a failure diagnosis result of the expansion unit as a result of executing the failure detection program.

13. The control method of the electronic device of claim 12, wherein the failure detection program is acquired from a server connected to the electronic device via a network.

14. The control method of the electronic device of claim 12, wherein the failure detection program is acquired from a broadcast wave received by the electronic device.

15. The control method of the electronic device of claim 12, wherein the failure diagnosis result is output to at least one of a displaying portion of the electronic device, a sound outputting portion of the electronic device and a user support center connected to the electronic device via a network.

16. The control method of the electronic device of claim 12, wherein the expansion unit is a tuner, an image playback device, a hard disk drive for recording or a high image quality unit.

17. A recording medium storing a control program of an electronic device to cause a computer to:
identify an expansion unit connected to the electronic device;
execute a failure detection program stored in the expansion unit for the expansion unit or a failure detection program acquired from outside for the expansion unit; and
output a failure diagnosis result of the expansion unit as a result of executing the failure detection program.

18. The recording medium of claim 17, wherein the control program is configured to cause the computer further to acquire the failure detection program from a server connected to the electronic device via a network.

19. The recording medium of claim 17, wherein the control program is configured to cause the computer further to acquire the failure detection program from a broadcast wave received by the electronic device.

20. The recording medium of claim 17, wherein the control program is configured to cause the computer further to output the failure diagnosis result to at least one of a displaying portion of the electronic device, a sound outputting portion of the electronic device and a user support center connected to the electronic device via a network.
